(19) United States
(12) Patent Application Publication
(10) Pub. No.: US 2024/0127396 A1
(43) Pub. Date: Apr. 18, 2024

(54) METHODS AND APPARATUS TO IMPLEMENT SUPER-RESOLUTION UPSCALING FOR DISPLAY DEVICES

(71) Applicant: Intel Corporation, Santa Clara, CA (US)

(72) Inventors: Petrus Van Beek, Vancouver, WA (US); Chyuan-Tyng Wu, San Jose, CA (US)

(21) Appl. No.: 18/397,751

(22) Filed: Dec. 27, 2023

Related U.S. Application Data
(60) Provisional application No. 63/594,871, filed on Oct. 31, 2023.

(51) Int. Cl. G06T 3/4053; G06T 3/4046

(52) U.S. Cl. CPC G06T 3/4053; G06T 3/4046

(57) ABSTRACT

Systems, apparatus, articles of manufacture, and methods are disclosed to generate super-resolution upscaling. An example apparatus to process an image disclosed herein includes interface circuitry to accept input image data with a first resolution, machine readable instructions, and programmable circuitry to at least one of instantiate or execute the machine readable instructions to upscale the input image data based on an upscale factor to generate intermediate image data with a second resolution higher than the first resolution, process the input image data with a neural network to produce neural network output data with a number of channels per pixel that is based on the upscale factor, combine the intermediate image and the neural network output data to generate output image data with the second resolution.

### RELATED APPLICATION

This patent claims the benefit of U.S. Provisional Patent Application No. 63/594,871, which was filed on Oct. 31, 2023. U.S. Provisional Patent Application No. 63/594,871 is hereby incorporated herein by reference in its entirety. Priority to U.S. Provisional Patent Application No. 63/594,871 is hereby claimed.

### FIELD OF THE DISCLOSURE

This disclosure relates generally to display devices and, more particularly, to implement super-resolution upscaling for display devices.

### BACKGROUND

Super-resolution upscaling is the process of enhancing the resolution or quality of an image beyond its original resolution. Super-resolution upscaling can be used to transform an input image at a relatively lower resolution to an output, upscaled image with relatively higher resolution for presentation by a display device.

### BRIEF DESCRIPTION OF THE DRAWINGS

FIG. 1 is a block diagram of an example environment in which example super-resolution circuitry operates to implement super-resolution upscaling in accordance with teachings of this disclosure.

FIG. 2 is a block diagram of an example implementation of the super-resolution circuitry of FIG. 1.

FIG. 3 is a block diagram of another example implementation of the super-resolution circuitry of FIG. 1.

FIG. 4 is a block diagram of an example implementation of the convolutional neural network circuitry of FIGS. 2 and/or 3.

FIG. 5 is a block diagram of an example implementation of the convolution block circuitry of FIG. 4.

FIG. 6 is a block diagram of another example implementation of the convolution block circuitry of FIG. 4.

FIG. 7 is a flowchart representative of example machine readable instructions and/or example operations that may be executed, instantiated, and/or performed by example programmable circuitry to implement the super-resolution circuitry of FIGS. 2 and/or 3.

FIG. 8 is a flowchart representative of example machine readable instructions and/or example operations that may be executed, instantiated, and/or performed by example programmable circuitry to implement the super-resolution circuitry of FIG. 2.

FIG. 9 is a flowchart representative of example machine readable instructions and/or example operations that may be executed, instantiated, and/or performed by example programmable circuitry to implement the super-resolution circuitry of FIG. 3.

FIG. 10 is a block diagram of an example processing platform including programmable circuitry structured to execute, instantiate, and/or perform the example machine readable instructions and/or perform the example operations of FIGS. 7-9 to implement the SR upscaling circuitry 108 of FIGS. 2 and 3.

FIG. 11 is a block diagram of an example implementation of the programmable circuitry of FIG. 10.

FIG. 12 is a block diagram of another example implementation of the programmable circuitry of FIG. 10.

FIG. 13 is a block diagram of an example software/firmware/instructions distribution platform (e.g., one or more servers) to distribute software, instructions, and/or firmware (e.g., corresponding to the example machine readable instructions of FIGS. 7-9) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

Examples disclosed herein are directed to a super-resolution system that generates an upscaled image with low power consumption. In a personal computer system that generates high resolution display, battery life and power consumption are important considerations. Higher resolution displays may demand substantial power due to their increased pixel count, which involves additional processing power to render and display an image. The increased computational demand leads to higher power consumption. The higher power consumption has an impact on battery life. A laptop that uses more power to generate a high-resolution display may deplete a battery faster compared to a lower-resolution display.

Some personal computer systems, laptops, tablets, etc., support different display resolution ranging from low to high resolution. For example a high-definition (HD) display resolution is 1280×720 pixels, a Full HD (FHD) display resolution is 1920×1080 pixels, a Quad HD (QHD) display resolution is 2560×1440 pixels, and an Ultra HD (UHD) display resolution is 3820×2160 pixels. A higher display resolution having higher pixel count translates to higher power consumption to create the content and present the data on the display.

Examples disclosed herein upscale a low resolution image to a high resolution image. The display content is generated at a low resolution (e.g., at FHD resolution), which is transformed to a display output at a higher resolution (e.g., UHD resolution). Examples disclosed herein may process a lower resolution image that does not contain high-frequency information that is present in high resolution image content to generate an output image with high visual quality. Examples disclosed herein may generate such a high resolution image while consuming little power (e.g., in the milliwatt (mW)).

Example super-resolution systems disclosed herein can be implemented using circuitry in a display timing controller (TCON) to generate a high resolution image and consumes less than 100 mW of power. In some examples, the super-resolution system utilizes a learned color space representation for interpreting color information that lets the super-resolution system work on one channel instead of multiple (e.g., three) input color channels. In some examples, the super-resolution system utilizes a quantization scheme that implements weight and data values associated with pixels in an image using 8-bit processing (int8) that utilizes low power consumption.

A color space representation is a method of organizing and interpreting color information in an image. Example super-resolution systems disclosed herein train a neural network to operate on a single-channel representation of an image rather than the red, green, blue (RGB) three-channel representation. The convolutional layers in the neural network are configured to handle one channel of information. The neural network upscales the input image to a higher resolution while maintaining important details.

The data values of an image are numerical values assigned to individual pixels in the image. In color images, each pixel has values for red, green, and blue channels (in the RGB color space). In grayscale images, each pixel represents the intensity of light at that specific location. For example, in an 8-bit image, pixel values can range from 0 to 255. A pixel value of 0 may represent black (minimum intensity), and a pixel value of 255 may represent white (maximum intensity). The values in between represent various shades of gray or colors.

A quantization scheme is the process of reducing the number of bits used to represent each pixel in an image. For example, an 8-bit image has (2⁸) or 256 possible values or levels, and can be quantized to a lower bit-depth such as 4 bits having (2⁴) or 16 levels, 2 bits having (2²) or 4 levels or even 1 bit (e.g., black and white image).

The super-resolution system disclosed herein is trainable end-to-end and includes two branches. The first branch in the super-resolution system performs a relatively low complexity upscaling of an input image with three-channels (e.g., RGB channels). The second branch in the super-resolution system performs a more complex neural network based upscaling on fewer channel that generates higher quality data that is more relevant to what a human sees. The super-resolution system combines the output from the first branch and the output from the second branch to get a high quality upscale image. The super-resolution system upscales a three-channels low resolution image without upscaling all the channels.

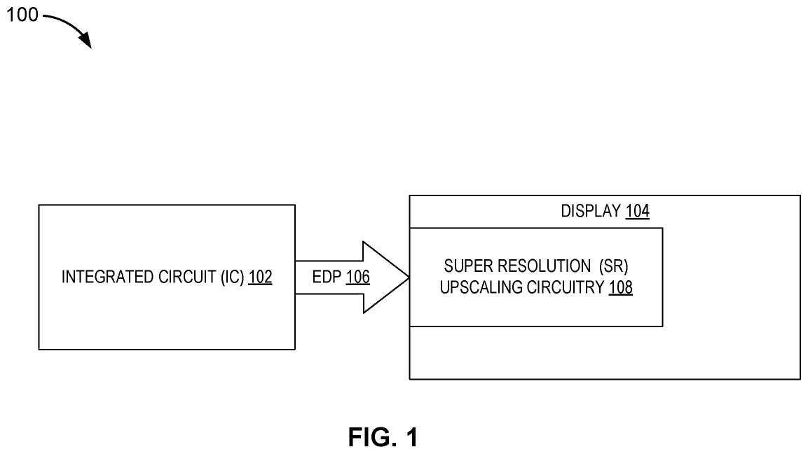

FIG. 1 is a block diagram of an example environment 100 in which example super-resolution circuitry operates to implement super-resolution upscaling in accordance with teachings of this disclosure. The example environment 100 includes an example integrated circuit 102, an example display 104 (also referred to as a display device 104), an example embedded display port (eDP) 106, and example super-resolution (SR) upscaling circuitry 108.

The example integrated circuit 102 may be a system-on-chip (SoC). The integrated circuit 102 generates the image content for display at a resolution lower than the display resolution to avoid high power consumption and bandwidth usage. The image or video is sent to the display 104 via the eDP 106.

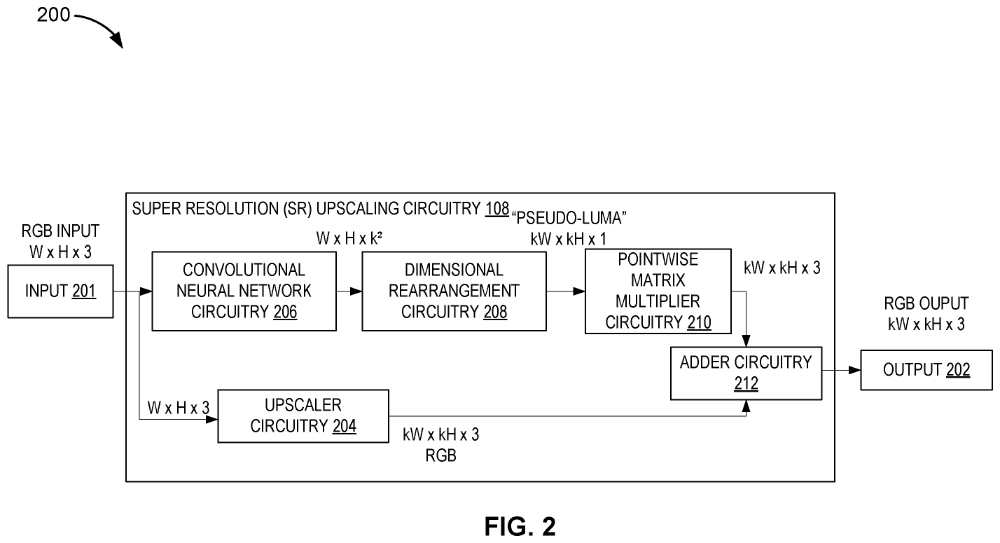

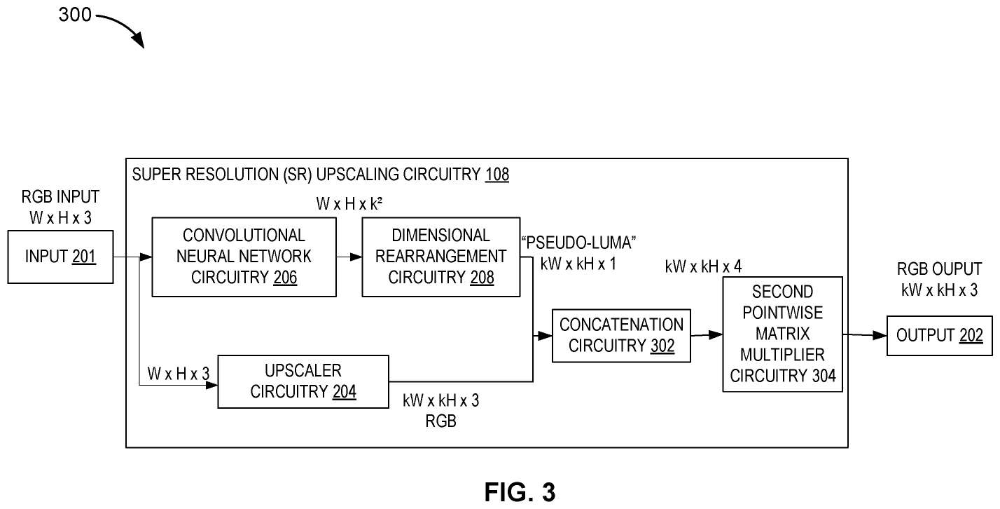

The image content with low resolution is received by the display 104 and upscaled by the SR upscaling circuitry 108 embedded in the display 104. The SR upscaling circuitry 108 is described in more detail below in connection with FIGS. 2 and 3.

FIG. 2 is a block diagram of an example implementation of the SR upscaling circuitry 108 of FIG. 1 to implement super-resolution upscaling of images. The SR upscaling circuitry 108 of FIG. 2 may be instantiated (e.g., creating an instance of, bring into being for any length of time, materialize, implement, etc.) by programmable circuitry such as a Central Processor Unit (CPU) executing first instructions. Additionally or alternatively, the SR upscaling circuitry 108 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

The example SR upscaling circuitry 108 receives an input image at an input 201 from the integrated circuit 102 and upscales the input image from a first, low resolution to a second, high resolution and outputs the upscaled image at the output 202. The SR upscaling circuitry 108 includes example upscaler circuitry 204, example convolutional neural network (CNN) circuitry 206, example dimensional rearrangement circuitry 208, example pointwise matrix multiplier circuitry 210 and example adder circuitry 212.

The SR upscaling circuitry 108 includes two branches. A first branch performs a relatively low complexity upscaling of an input image with three-channels (e.g., RGB channels). A second branch with a more complex neural network based upscaling performs upscaling on fewer channels that generates higher quality data that is more relevant to what a human eye sees. The first branch includes the upscaler circuitry 204. The second branch includes the CNN circuitry 206. The SR upscaling circuitry 108 further includes a combination stage to combine the output of the first branch and the output of the second branch. The output of the two branches are combined with the dimensional rearrangement circuitry 208, the pointwise matrix multiplier circuitry 210 and the adder circuitry 212.

The example upscaler circuitry 204 upscales the three-channel input image received from the integrated circuit 102. The input image is a three-channel input image with red, green, and blue (RGB) channels. The input image has a first resolution which is a low resolution such as the HD resolution with 1280×720 pixels. The upscaler circuitry 204 upscales or enlarges the spatial size of the input image with low resolution, based on an upscale factor, K. For example, the upscale factor K can be any numerical value determined by a user, configures as a design parameter, etc. In the illustrated example, the two spatial dimensions of the input image (e.g, the width and the height) are enlarged by the upscale factor of K. The upscaling operation implemented by the upscaler circuitry 204 upscales the chrominance (e.g., color) information of the input image. This upscaling operation can be performed by a low-complexity processing technique such as upscaling with nearest-neighbor interpolation, bilinear interpolation, bicubic interpolation, or similar conventional upscaling techniques. The low complexity of the computational processing utilized by the upscaler circuitry 204 results in relatively low power consumption. This does not impact the visual perception quality of the image since the human visual system is less sensitive to high-frequency detail in chrominance (e.g., color) components than luminance (e.g., brightness) components of the image.

In some examples, the upscaler circuitry 204 implements nearest-neighbor interpolation by pixel replication. In some such examples, respective pixels of the image are replicated horizontally and vertically without calculation involved. The upscaler circuitry 204 provides a low cost baseline upscaled image including at least the low frequency information present in the input image. The input RGB image pixels may be represented at 8-bit in the standard range of [0 . . . 255]. In this case, the input image data is processed in the [0 . . . 255] pixel value range without losing precision, using pixel replication, bilinear, bicubic or other interpolation. The upscaler circuitry 204 outputs an intermediate image that retains the 8-bit precision and avoids quality degradations in the low frequency information. In some examples, the input and output bit precision may be 10-bit, 12-bit, or 16-bit. Loss of bit precision in the lower frequency components is highly visible in smoothly varying areas of the image, away from edges and sharp features, and is avoided. Image upscaling performed in this manner results in low computational cost and without loss of bit precision.

The upscaler circuitry 204 upscales the chrominance component and provides an upscaled version of the luminance (e.g., brightness) component within each color channel. Based on the upscaled luminance and chrominance component of the three-channel in the input image, the upscaler circuitry 204 generates an intermediate image data with a second resolution higher than the first resolution. In some examples the second resolution may be the FHD resolution, the QHD resolution, the UHD resolution or any other higher resolution (e.g., with higher pixel count).

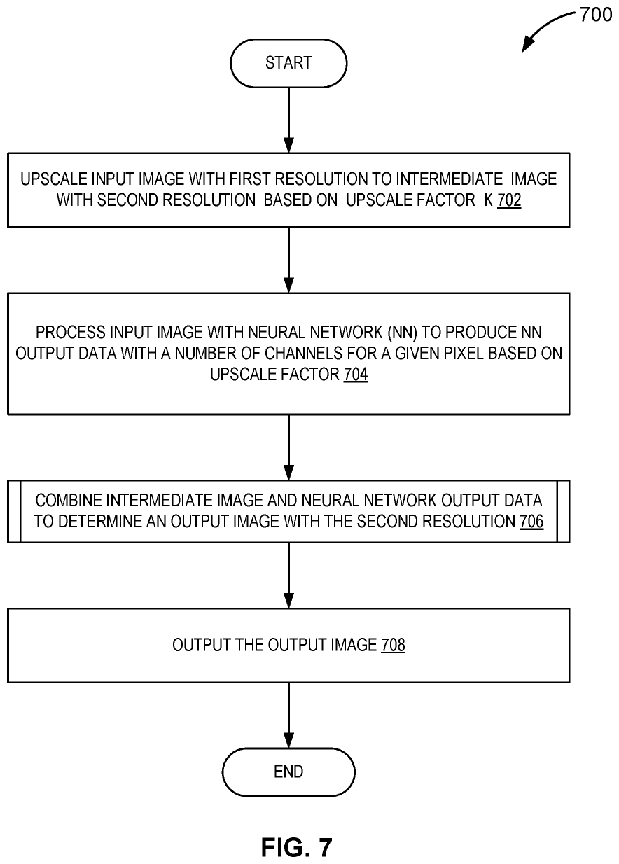

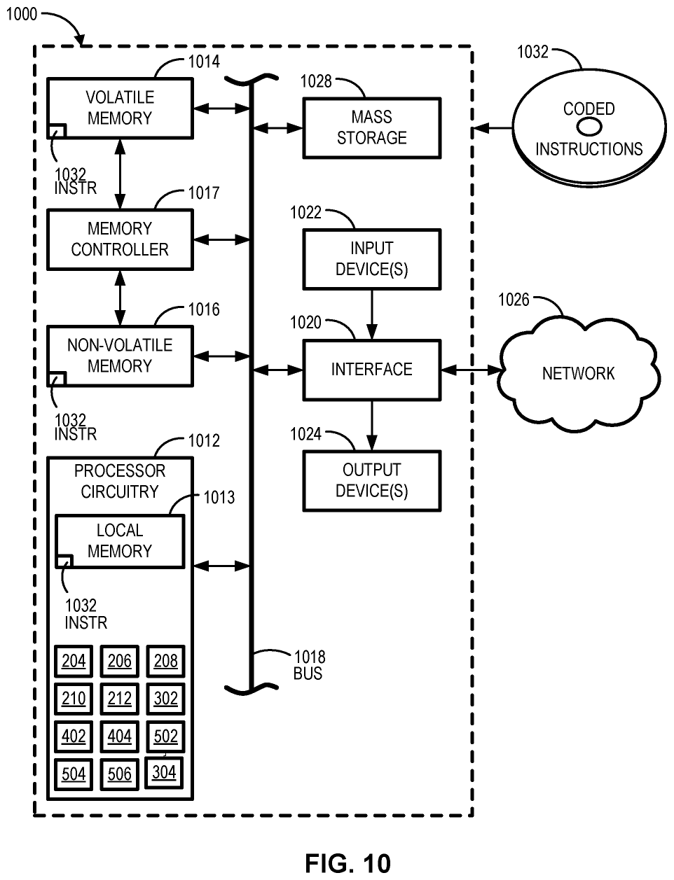

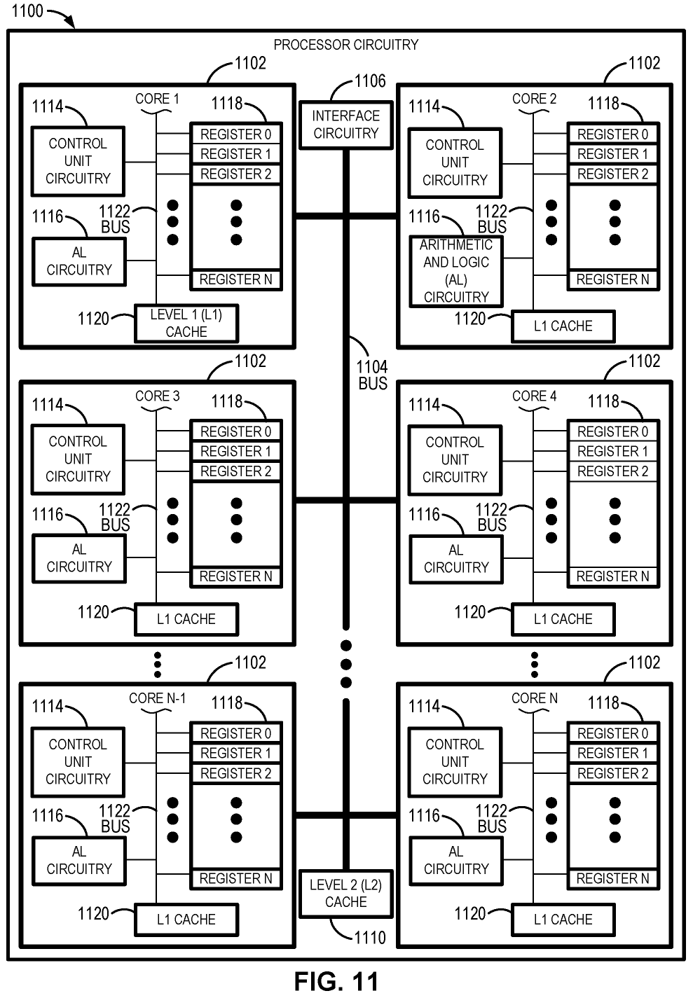

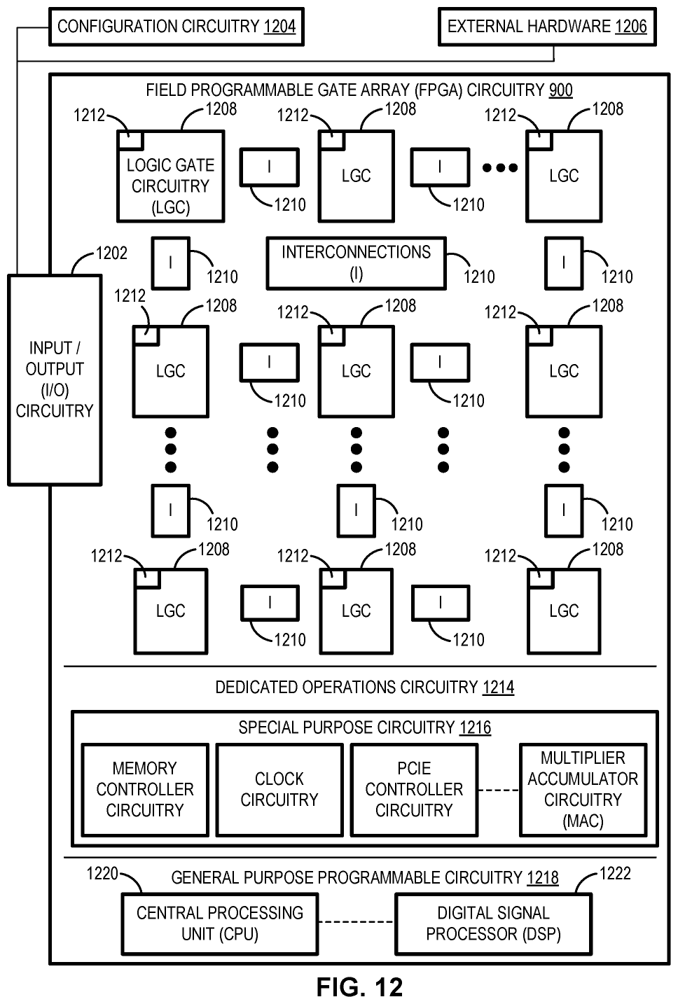

In some examples, the SR upscaling circuitry 108 includes means for upscaling the input image data based on an upscale factor. For example, the means for upscaling may be implemented by the upscaler circuitry 204. In some examples, the upscaler circuitry 204 may be instantiated by programmable circuitry such as the example programmable circuitry 1012 of FIG. 10. For instance, the upscaler circuitry 204 may be instantiated by the example microprocessor 1100 of FIG. 11 executing machine executable instructions such as those implemented by at least blocks 702 of FIG. 7. In some examples, the upscaler circuitry 204 may be instantiated by hardware logic circuitry, which may be implemented by an ASIC, XPU, or the FPGA circuitry 1200 of FIG. 12 configured and/or structured to perform operations corresponding to the machine readable instructions. Additionally or alternatively, the upscaler circuitry 204 may be instantiated by any other combination of hardware, software, and/or firmware. For example, the upscaler circuitry 204 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example convolutional neural network (CNN) circuitry 206 operates on the three-channel (e.g., RGB) input image to produce convolutional neural network (CNN) output data. The CNN output data has multiple channels for a given pixel. The multiple channels are generated based on the upscale factor K. For example, when upscaling by a factor of K=2 in both dimensions (e.g., width and height), the minimum number of channels produced by the CNN circuitry 206 is for a given pixel is the square of the upscale factor, e.g., K²=4. As another example, when upscaling by a factor K=3 in both dimensions, the number of channels produced by the CNN circuitry 206 for a given example is K²=9. In some examples, the number of channels produced by the CNN circuitry is a multiple of K² (e.g., M×K²). For example, M may be 2, 3, or 4, and when K²⁼⁴, the number of channels is 8, 12, or 16.

The CNN circuitry 206 is trainable and is capable of learning color transformations implicitly in its convolutional weights, without any explicit color conversion from red, green, and blue (RGB) to a luminance-chrominance color space (for example, YUV ((Y) luma, or brightness, (U) blue projection and (V) red projection), or YCbCr ((Y) luma, (Cb) blue minus luma, and (Cr) red minus luma)) or vice versa. The input and output of the CNN circuitry 206 may be in a three-channel RGB color space. The CNN circuitry 206 transforms the three-channel input to a smaller number of channels (e.g., such as one channel in the illustrated example) with higher resolution which encodes high-frequency information. This is referred to as pseudo-luminance information since there is no explicit or pre-designed color transformation.

The CNN circuitry 206 is trained with an appropriate data set, in order to focus visual quality on the type of content that is relevant and impacts subjective visual quality. In some examples, the CNN circuitry 206 is trained with a data set that is tailored to personal computer (PC) content and results in high visual quality. The data set is focused on high quality desktop content with sharp features (e.g., sharp lines, edges, contours) such as text and two-dimensional (2-D) graphics. The CNN circuitry 206 learns and adjusts trainable weights, also referred to as trained coefficients, based on the data set.

In some examples, the weights and activations (e.g., image data being processed) of the CNN circuitry 206 are quantized to 8-bit precision, which enables int8 fixed-point computation and memories. This results in significant power savings and/or frame processing throughput compared to executing the network in floating-point representation.

Quantization of the neural network weights of the CNN circuitry 206 to 8-bit precision can be achieved using post-training quantization or quantization-aware training Both are known techniques that adaptively determine quantization parameters based on the statistics of the weights during or after their training In some examples, quantization of the neural network weights is symmetric around 0, and is “per filter.” In some examples, different convolutional filters that generate their own respective output channel may have their own respective quantization parameters, also referred to as scale parameters, which map a floating-point range to the 8-bit fixed-point range. The convolution filter, also known as kernel, is a small matrix applied to input data to perform operations like feature detection and extraction.

Quantization of activations (e.g., image data) is asymmetric around 0 and is “per tensor” (e.g., the outputs of each neural net layer has its own quantization parameters), shared amongst multiple channels. The quantization parameters include an offset and a scale. The super-resolution upscaling circuitry 108 with the two branch network determines these quantization parameters for the activations (e.g., data values) at a particular precision level, such as 8-bit precision or some other precision level.

The CNN circuitry 206 processes residual data and creates high-frequency details. Residual data refers to the differences between the predicted values and ground truth values. The CNN circuitry 206 may predict an upscaled version of an image, and the residuals represent the differences between this prediction and the actual image. The detail information generation in the CNN circuitry 206 occurs near edges and sharp features in the image. In some examples, these residual (differential) data values is mapped to an 8-bit fixed-point data range, either [0 . . . 255] or [−128 . . . 127], using appropriate quantization scale and offset factors. This process works well in practice, even with few channels, precisely because it is applied to residual data, which has a narrower statistical distribution compared to natural pixel data. The quantization scale and offsets factors is optimally determined based on the statistics of the data values at each layer of the network, which is performed off-line based on a training data set. In some examples, quantization parameters of the final output layer is restricted, as the final output layer generates data values in the standard image pixel range of [0 . . . 255] in the case of 8-bit input and output image data.

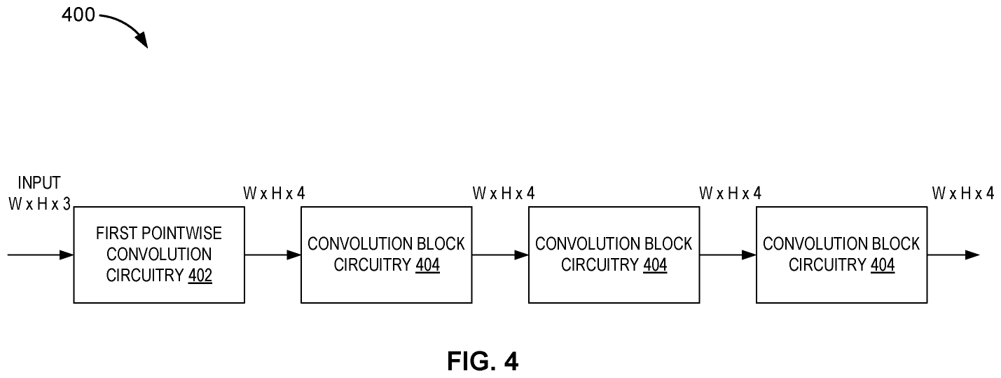

In some examples, the CNN circuitry 206 includes an example first pointwise convolution circuitry 402, and one or more instances of example convolution block circuitry 404, as shown in FIG. 4. The first pointwise convolution circuitry 402 expands the number of channels based on the upscale factor K. For example, an upscale factor K=2 produces a number of 4 channels in both dimensions. The lowest number of channels is selected to have low computational costs and low power consumption. A higher number of channels may be utilized based on a higher upscale factor and having a higher computational budget.

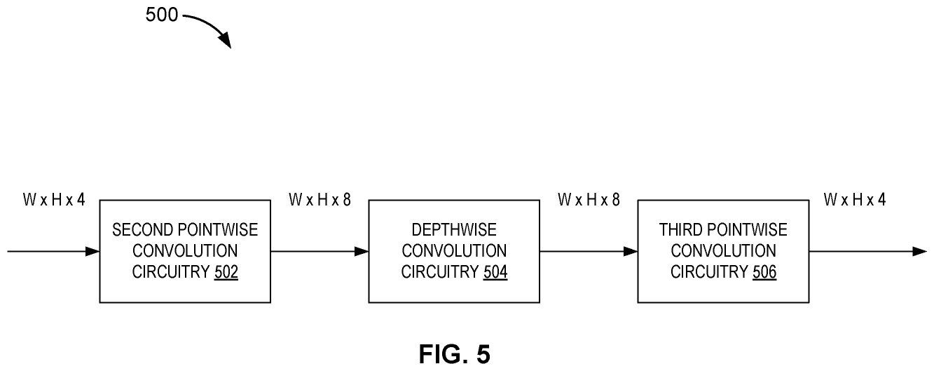

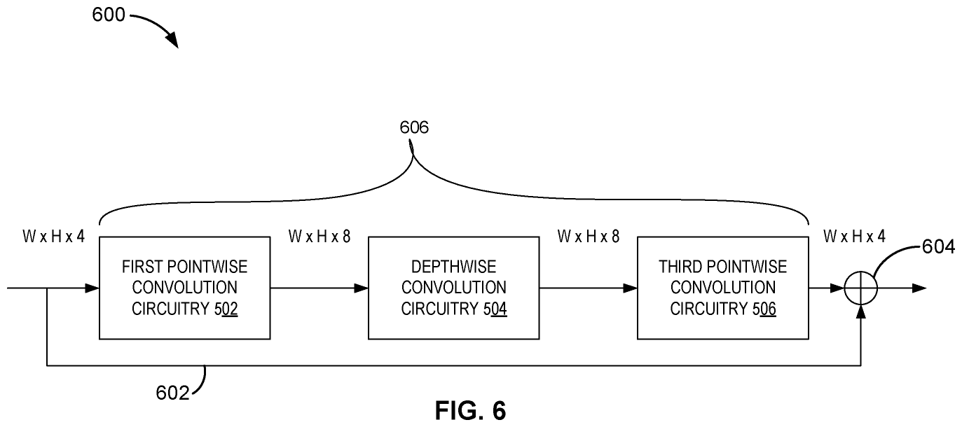

The convolution block 404 includes one or more convolution layers (e.g., convolution layers depicted in the convolution block 500 of FIG. 5, convolution layers depicted in the residual convolution block 600 of FIG. 6). The number of convolution blocks 404 included in the CNN circuitry 206 can be selected based on a computational budget and a desired visual quality. The CNN circuitry 206 maintains the number of channels to 4 channels throughout the network to ensure low power consumption. FIGS. 5 and 6 describes two variants of the convolution block circuitry 404.

FIG. 5 illustrates an example convolution block circuitry 500 that may be used to implement one or more of the instances of the convolution block circuitry 404 of FIG. 4. The convolutional blocks 500 extracts and enhances features from the input image. The convolution block 500 includes example second pointwise convolution circuitry 502, example depthwise convolution circuitry 504 and example third pointwise convolution circuitry 506 which corresponds to different convolution layers. The second pointwise convolution circuitry 502 is a convolution layer that expands the number of channels from 4 channels to 8 channels. A pointwise convolution is a convolutional operation used in neural networks. The second pointwise convolution circuitry 502 performs pointwise convolution operation on the channel dimension. The pointwise convolution uses a 1×1 filters which apply the convolution independently to each element along the channel dimension. The number of channels can be expanded to 8 channels by setting the number of filters to 8. The convolutional operation is performed independently for each channel in the input image. Each channel is treated as a separate one dimensional sequence, and the convolution is applied channel-wise.

The depthwise convolution circuitry 504 is a convolution layer that applies the convolution operation along one spatial dimension (e.g., channel). In some examples, the depthwise convolution circuitry 504 may be replaced with one or more full convolution circuitry. A depthwise convolution circuitry 504 applies a separate convolutional filter (e.g., kernel) to each of the 8 input channel separately. This involves applying a 2-dimensional (2D) convolution with a separate filter for each input channel. This convolution operation captures spatial features independently for each channel. The purpose of depthwise convolutions is to reduce computational complexity and extract basic spatial features.

Following the depthwise convolution operation, a pointwise convolution is applied by the third pointwise convolution circuitry 506. The third pointwise convolution circuitry 506 is a convolution layer that further refines the features. The pointwise convolution operation increases the representational capacity of the network and captures more complex patterns by applying additional non-linear transformations to the channel-wise information. The third pointwise convolution circuitry 506 combines the information across the channels and reduces the 8 channels back to 4 channels.

FIG. 6 illustrates another example convolution block circuitry 600 that may be used to implement one or more of the instances of the convolution block circuitry 404 of FIG. 4. The convolution block circuitry 600 is similar to the convolution block 500 of FIG. 5 but includes an example skip connection 602, also referred to as an example residual connection 602, and example addition circuitry 604. In addition to passing the input through a main path 606 including the second pointwise convolution circuitry 502, the depthwise convolution circuitry 504 and the third pointwise convolution 506, the input directly passes through the skip connection 602 to the output of the main path, forming a shortcut connection. The addition circuitry 604 adds the skip connection to the output of the main path. The purpose of the skip connection is to allow the network to learn the residual (the difference between the desired output and the input) rather than the entire transformation. This helps mitigate vanishing gradient problems, thus enabling the training of deep neural networks. The vanishing gradient problems is encountered during training of deep neural networks with many layers. It is characterized by the diminishing magnitude of the gradients as they are backpropagated from the output layer to the input layer during the training process. Neural networks are typically trained using optimization algorithms such as gradient descent. Backpropagation is the process of computing gradients with respect to the loss function for each parameter in the network. Gradients indicate the direction and magnitude of change needed to minimize the loss. During backpropagation, gradients are propagated backward through the network. As the gradients traverse each layer, the gradients are multiplied by the weights of the corresponding layer. If these weight multipliers are small (e.g., less than 1), the gradient magnitude diminishes exponentially as it moves backward through the layers.

In some examples, the vanishing gradient problem can be addressed by combining each convolution layers, 502, 504, 506 with a batch-normalization layer during the training phase. Normalizing activations within the convolution layers 502, 504, 506 help stabilize and propagate the gradients. Also, one or more convolution layers may be followed by a non-linear activation function. For example, a non-linear activation function may be a rectified linear unit (e.g., ReLU). The ReLU may be utilized on the first convolution layer 502, and second convolution layer 504 in each convolution block 500. A ReLU has low computational complexity as it is implemented by simple clipping. Simple clipping is where the output is clipped to a maximum value, preventing the output from becoming too large.

Returning to FIG. 2, the CNN circuitry 206 performs an inference task using a trained model to make predictions or classifications on image data with reduced power consumption (e.g., low power inference). In some examples, the CNN circuitry 206 may implement its inference task with int8 calculations which results in efficient power consumption. In some examples, the number of calculations performed by the CNN circuitry 206 when processing the input image data with this neural network is low, about 125 giga operations per second (G-ops/sec). The inference can be executed by pipelining and/or fusing sequences of convolutional layers, so a limited amount of intermediate data is stored between layers. This allows utilizing small local memories for intermediate data storage and reduces memory bandwidth. It avoids using host RAM or off-chip RAM. This may involve line-based, block-based or tile-based processing (e.g., processing the image data in small portions, so the data fits in local memories).

In some examples, the CNN circuitry 206 is implemented with a neural network inference processor. Neural network inference processors are designed to run a variety of neural networks in an optimized and efficient manner A neural network compiler is used to compile the network for the specific neural network inference processor. Some example neural network inference processors support convolutional neural networks using int8 calculations. As described above, one or more neural network inference processors may implement the CNN circuitry 206 by pipelining different neural network layers, and utilizing tiling of the image and tensor activation data, or line-based or block-based processing, to reduce memory bandwidth.

In some examples, the CNN circuitry 206 is implemented with dedicated fixed-function hardware. Dedicated fixed-function hardware for convolutional neural networks can be optimized for a limited set of neural networks. In some examples, the dedicated hardware processes the data in a tile-based, line-based, or block-based manner, such that different network layers may be pipelined, and intermediate data is stored in small local memories, as described above. The hardware design can be further specialized for a particular neural network architecture to improve performance and efficiency in terms of increasing throughput, reducing latency, reducing memory bandwidth, reducing power consumption, etc.

In some examples, the SR upscaling circuitry 108 includes means for processing the input image data with a neural network to produce neural network output data. For example, the means for processing the input image data and expanding the number of channels may be implemented by the convolutional neural network circuitry 206. In some examples, the convolutional neural network circuitry 206 may be instantiated by programmable circuitry such as the example programmable circuitry 1012 of FIG. 10. For instance, the convolutional neural network circuitry 206 may be instantiated by the example microprocessor 1100 of FIG. 11 executing machine executable instructions such as those implemented by at least blocks 704 of FIG. 7. In some examples, the convolutional neural network circuitry 206 may be instantiated by hardware logic circuitry, which may be implemented by an ASIC, XPU, or the FPGA circuitry 1200 of FIG. 12 configured and/or structured to perform operations corresponding to the machine readable instructions. Additionally or alternatively, the convolutional neural network circuitry 206 may be instantiated by any other combination of hardware, software, and/or firmware. For example, the convolutional neural network circuitry 206 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example dimensional rearrangement circuitry 208 rearranges the channels for each pixel of the neural network output data from the CNN circuitry 206 to form a rearranged output data. The rearranged output data forms a spatial block for each pixel. The spatial block for a given pixel has a number of vertical elements and a number of horizontal elements corresponding to the upscale factor, K. The dimensional rearrangement circuitry 208 turns an input pixel into a block of output pixels. The block of output pixels forms a channel for each channel. Therefore, the rearranged output data has one channel per pixel. The dimensional rearrangement circuitry 208 generates detailed information for a single channel of the image with high resolution which encodes high-frequency information. Since the human visual system is more sensitive to high-frequency information in the luminance (brightness) component relative to the high-frequency information in the chrominance (color) components, the dimensional rearrangement circuitry 208 focuses on generating high-frequency luminance information, also referred to as pseudo-luminance information. In some examples, the input to the dimensional rearrangement circuitry may consist of M×K² channels. In such cases, the rearranged data has M channels per pixel. In such examples, a high visual quality may be achieved, at a slightly higher computational cost.

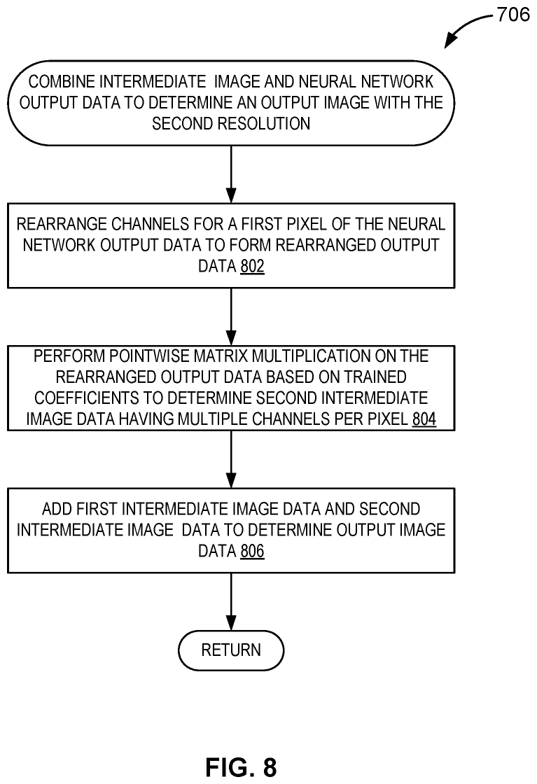

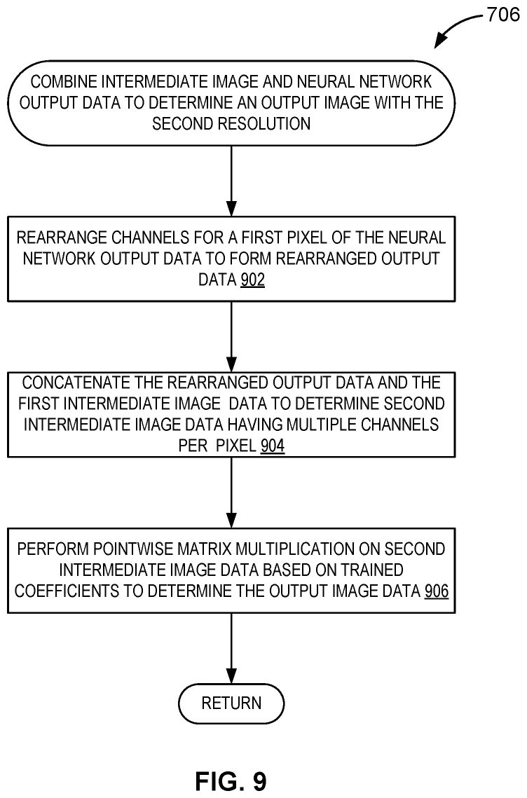

In some examples, the SR upscaling circuitry 108 includes means for rearranging channels for a first pixel of the neural network output data to form rearranged output data. For example, the means for rearranging channels may be implemented by the dimensional rearrangement circuitry 208. In some examples, the dimensional rearrangement circuitry 208 may be instantiated by programmable circuitry such as the example programmable circuitry 1012 of FIG. 10. For instance, the dimensional rearrangement circuitry 208 may be instantiated by the example microprocessor 1100 of FIG. 11 executing machine executable instructions such as those implemented by at least blocks 802 of FIG. 8 and 902 of FIG. 9. In some examples, the dimensional rearrangement circuitry 208 may be instantiated by hardware logic circuitry, which may be implemented by an ASIC, XPU, or the FPGA circuitry 1200 of FIG. 12 configured and/or structured to perform operations corresponding to the machine readable instructions. Additionally or alternatively, the dimensional rearrangement circuitry 208 may be instantiated by any other combination of hardware, software, and/or firmware. For example, the dimensional rearrangement circuitry 208 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example pointwise matrix multiplier circuitry 210 performs pointwise matrix multiplication on the rearranged output data based on trained coefficients to determine second intermediate image data having multiple channels per pixel. The pointwise matrix multiplier circuitry 210 multiplies each pixel value in the image of the rearranged output data by scaling factors (e.g., trainable coefficients). The pointwise matrix multiplier circuitry 210 generates pixel values in the RGB color space (three-channels). The convolution and multiplication weights (e.g., trained coefficients) are learned and optimized via training In some examples, the pointwise matrix multiplier circuitry 210 performs pointwise matrix multiplication on the second intermediate image data based on trained coefficients to determine the output image data.

In some examples, the SR upscaling circuitry 108 includes means for performing pointwise matrix multiplication on the rearranged output data and/or the second intermediate image data. For example, the means for performing pointwise matrix multiplication may be implemented by the pointwise matrix multiplier circuitry 210. In some examples, the pointwise matrix multiplier circuitry 210 may be instantiated by programmable circuitry such as the example programmable circuitry 1012 of FIG. 10. For instance, the pointwise matrix multiplier circuitry 210 may be instantiated by the example microprocessor 1100 of FIG. 11 executing machine executable instructions such as those implemented by at least blocks 804 of FIG. 8 and 906 of FIG. 9. In some examples, the pointwise matrix multiplier circuitry 210 may be instantiated by hardware logic circuitry, which may be implemented by an ASIC, XPU, or the FPGA circuitry 1200 of FIG. 12 configured and/or structured to perform operations corresponding to the machine readable instructions. Additionally or alternatively, the pointwise matrix multiplier circuitry 210 may be instantiated by any other combination of hardware, software, and/or firmware. For example, the pointwise matrix multiplier circuitry 210 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example adder circuitry 212 adds or combines the intermediate image and the neural network output data to generate output image data with the second resolution. For example the output image data is a output image with three channel (e.g., RGB) with a spatial size (e.g., width (W) and height (H)) multiplied by the upscale factor, K.

In some examples, the SR upscaling circuitry 108 includes means for combining the intermediate image and the neural network output data to generate output image data with the second resolution. For example, the means for combining the intermediate image and the neural network output data, adding the first intermediate image data and the second intermediate image data may be implemented by the adder circuitry 212. In some examples, the adder circuitry 212 may be instantiated by programmable circuitry such as the example programmable circuitry 1012 of FIG. 10. For instance, the adder circuitry 212 may be instantiated by the example microprocessor 1100 of FIG. 11 executing machine executable instructions such as those implemented by at least blocks 706 of FIG. 7 and 806 of FIG. 8. In some examples, the adder circuitry 212 may be instantiated by hardware logic circuitry, which may be implemented by an ASIC, XPU, or the FPGA circuitry 1200 of FIG. 12 configured and/or structured to perform operations corresponding to the machine readable instructions. Additionally or alternatively, the adder circuitry 212 may be instantiated by any other combination of hardware, software, and/or firmware. For example, the adder circuitry 212 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

FIG. 3 is a block diagram of another example implementation of the SR upscaling circuitry 108 of FIG. 1 to generate super-resolution upscaling. The SR upscaling circuitry 108 of FIG. 3 may be instantiated (e.g., creating an instance of, bring into being for any length of time, materialize, implement, etc.) by programmable circuitry such as a Central Processor Unit (CPU) executing first instructions. Additionally or alternatively, the SR upscaling circuitry 108 of FIG. 3 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 3 may, thus, be instantiated at the same or different times. Some or all of the circuitry of FIG. 3 may be instantiated, for example, in one or more threads executing concurrently on hardware and/or in series on hardware. Moreover, in some examples, some or all of the circuitry of FIG. 3 may be implemented by microprocessor circuitry executing instructions and/or FPGA circuitry performing operations to implement one or more virtual machines and/or containers.

FIG. 3 illustrates another example implementation of the SR upscaling circuitry 108 of FIG. 1. Many of the blocks of FIG. 3 are the same or similar to those present in FIG. 2. In the interest of brevity, those blocks will not be re-described here. Instead, the interested reader is referred to the above description of FIG. 2 for a full and complete description of the blocks in the block diagram. To facilitate that process, like reference numbers are used for like blocks in FIGS. 2 and 3. In the illustrated example 300 of FIG. 3, the concatenation circuitry 302 concatenates the rearranged output data of the dimensional rearrangement circuitry 208 and the first intermediate image data of the upscaler circuitry 204 to determine second intermediate image data having multiple channels per pixel. The concatenation process is done along the channel axis. The concatenation circuitry combines the high resolution features from the dimensional rearrangement circuitry 208 with the upscaled information from the upscaler circuitry 204 to generate a second intermediate image data. The concatenation process preserves the fine details and enhance the quality of the final output image.

In some examples, the SR upscaling circuitry 108 includes means for concatenating the rearranged output data and the first intermediate image data to determine second intermediate image data. For example, the means for concatenating the rearranged output data and the first intermediate image data may be implemented by the concatenation circuitry 302. In some examples, the concatenation circuitry 302 may be instantiated by programmable circuitry such as the example programmable circuitry 1012 of FIG. 10. For instance, the concatenation circuitry 302 may be instantiated by the example microprocessor 1100 of FIG. 11 executing machine executable instructions such as those implemented by at least block 904 of FIG. 9. In some examples, the concatenation circuitry 302 may be instantiated by hardware logic circuitry, which may be implemented by an ASIC, XPU, or the FPGA circuitry 1200 of FIG. 12 configured and/or structured to perform operations corresponding to the machine readable instructions. Additionally or alternatively, the concatenation circuitry 302 may be instantiated by any other combination of hardware, software, and/or firmware. For example, the concatenation circuitry 302 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The concatenated features of the second intermediate image are processed further to generate the final output. The second pointwise matrix multiplier circuitry 304 performs pointwise matrix multiplication on the second intermediate image data based on trained coefficients to determine the output image data. Trainable weights (e.g., coefficients) are used to scale the elements of one matrix before multiplying. The second pointwise matrix multiplier circuitry 304 introduces learnable weights for combining information from the different branches. Pointwise matrix multiplication uses trainable parameters to scale and adjust the contributions of the concatenated features before generating the final output image. The final output image is a three-channel (e.g., RGB) output image displayed on the output 202.

In some examples, the SR upscaling circuitry 108 includes means for performing pointwise matrix multiplication on the second intermediate image data based on trained coefficients. For example, the means for performing pointwise matrix multiplication may be implemented by the second pointwise matrix multiplier circuitry 304. In some examples, the second pointwise matrix multiplier circuitry 304 may be instantiated by programmable circuitry such as the example programmable circuitry 1012 of FIG. 10. For instance, the second pointwise matrix multiplier circuitry 304 may be instantiated by the example microprocessor 1100 of FIG. 11 executing machine executable instructions such as those implemented by at least block 904 of FIG. 9. In some examples, the second pointwise matrix multiplier circuitry 304 may be instantiated by hardware logic circuitry, which may be implemented by an ASIC, XPU, or the FPGA circuitry 1200 of FIG. 12 configured and/or structured to perform operations corresponding to the machine readable instructions. Additionally or alternatively, the second pointwise matrix multiplier circuitry 304 may be instantiated by any other combination of hardware, software, and/or firmware. For example, the second pointwise matrix multiplier circuitry 304 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the SR upscaling circuitry 108 of FIG. 1 is illustrated in FIGS. 2 and 3, one or more of the elements, processes, and/or devices illustrated in FIGS. 2 and 3 may be combined, divided, re-arranged, omitted, eliminated, and/or implemented in any other way. Further, the example upscaler circuitry 204, the example convolutional neural network circuitry 206, the example dimensional arrangement circuitry 208, the example pointwise matrix multiplier circuitry 210, the example adder circuitry 212, the example concatenation circuitry 302, the example second pointwise matrix multiplier circuitry 304, the example first pointwise convolution circuitry 402, the example convolution block circuitry 404, the example second pointwise convolution circuitry 502, the example depthwise convolution circuitry 504, the example third pointwise convolution circuitry 506 and/or, more generally, the example SR upscaling circuitry 108 of FIGS. 2 and 3, may be implemented by hardware alone or by hardware in combination with software and/or firmware. Thus, for example, any of the example upscaler circuitry 204, the example convolutional neural network circuitry 206, the example dimensional arrangement circuitry 208, the example pointwise matrix multiplier circuitry 210, the example adder circuitry 212, the example concatenation circuitry 302, the example second pointwise matrix multiplier circuitry 304 the example first pointwise convolution circuitry 402, the example convolution block circuitry 404, the example second pointwise convolution circuitry 502, the example depthwise convolution circuitry 504, the example third pointwise convolution circuitry 506, and/or, more generally, the example SR upscaling circuitry 108, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example SR upscaling circuitry 108 of FIGS. 2 and 3 may include one or more elements, processes, and/or devices in addition to, or instead of, those illustrated in FIGS. 2 and 3, and/or may include more than one of any or all of the illustrated elements, processes and devices.

Flowchart(s) representative of example machine readable instructions, which may be executed by programmable circuitry to implement and/or instantiate the SR upscaling circuitry 108 of FIGS. 2 and 3 and/or representative of example operations which may be performed by programmable circuitry to implement and/or instantiate the SR upscaling circuitry 108 of FIGS. 2 and 3, are shown in FIGS. 7-9. The machine readable instructions may be one or more executable programs or portion(s) of one or more executable programs for execution by programmable circuitry such as the programmable circuitry 1012 shown in the example processor platform 1000 discussed below in connection with FIG. 10 and/or may be one or more function(s) or portion(s) of functions to be performed by the example programmable circuitry (e.g., an FPGA) discussed below in connection with FIGS. 11 and/or 12. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 7-9, many other methods of implementing the example SR upscaling circuitry 108 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 7-9 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 7 is a flowchart representative of example machine readable instructions and/or example operations 700 that may be executed, instantiated, and/or performed by programmable circuitry to generate a super-resolution upscaling output image. The example machine-readable instructions and/or the example operations 700 of FIG. 7 begin at block 702, at which the upscaler circuitry 204 upscales the input image with a first resolution to an intermediate image with a second resolution based on an upscale factor, K. As described above in connection with FIG. 2, the upscaler circuitry 204 upscales the RGB input image which also indirectly upscales the chrominance component and the luminance component of the input image with a first resolution (e.g., low resolution). The output image is an intermediate image with a second resolution higher than the first resolution.

At block 704, the example convolutional neural network 206 processes the input image with a neural network to produce a neural network output data with a number of channels for a given pixel based on the upscale factor, K. At block 706, the adder circuitry 212 combines the intermediate image and the neural network output data to generate an output image data with the second resolution (e.g., higher resolution), as further described below in connection with FIGS. 8 and 9. At block 708, the output 202 outputs the output image data. The output image data is an upscaled image with a display resolution higher than the input image with the first resolution. The example instructions and/or operations 700 of FIG. 7 end.

FIG. 8 is a flowchart representative of example machine readable instructions and/or example operations 706 that may be executed, instantiated, and/or performed by programmable circuitry to combine intermediate image and neural network output data to generate an output image data with second resolution. The example machine-readable instructions and/or the example operations 706 of FIG. 8 begin at block 802, at which the dimensional rearrangement circuitry 208 rearranges the channels for a first pixel of the neural network output data to form a rearranged output data. The rearranged output data has one channel per pixel and includes a spatial block for each pixel. the spatial block has a number of vertical elements and horizontal elements corresponding to the upscale factor, K.

At block 804, the pointwise matrix multiplier circuitry 210 performs pointwise matrix multiplication on the rearranged output data based on trained coefficients to determine a second intermediate image data having multiple channels per pixel. At block 806, the adder circuitry 212 adds or combines the first intermediate image data and second intermediate image data to determine an output image data. Control returns to the example instructions and/or operations of block 708 of FIG. 7, and the example instructions and/or operations 706 of FIG. 8 end.

FIG. 9 is an alternative flowchart representative of example machine readable instructions and/or example operations 706 that may be executed, instantiated, and/or performed by programmable circuitry to combine intermediate image and neural network output data to generate an output image data with second resolution. The example machine-readable instructions and/or the example operations 706 of FIG. 9 begin at block 902, at which the dimensional rearrangement circuitry 208 rearranges the channels for a first pixel of the neural network output data to form a rearranged output data. At block 904, the concatenation circuitry 302 concatenate the rearranged output data and the first intermediate image data to determine a second intermediate image data having multiple channels per pixel. At block 906, the second pointwise matrix multiplier circuitry 304 performs pointwise matrix multiplication on the second intermediate image data based on the trained coefficients to determine the output image data. Control returns to the example instructions and/or operations of block 708 of FIG. 7, and the example instructions and/or operations 706 of FIG. 9 end.

FIG. 10 is a block diagram of an example programmable circuitry platform 1000 structured to execute and/or instantiate the example machine-readable instructions and/or the example operations of FIGS. 7-9 to implement the SR upscaling circuitry 108 of FIGS. 2 and 3. The programmable circuitry platform 1000 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 1000 of the illustrated example includes programmable circuitry 1012. The programmable circuitry 1012 of the illustrated example is hardware. For example, the programmable circuitry 1012 can be implemented by one or more integrated circuits, logic circuits, FPGAs, microprocessors, CPUs, GPUs, DSPs, and/or microcontrollers from any desired family or manufacturer. The programmable circuitry 1012 may be implemented by one or more semiconductor based (e.g., silicon based) devices. In this example, the programmable circuitry 1012 implements the example upscaler circuitry 204, the example convolutional neural network circuitry 206, the example dimensional arrangement circuitry 208, the example pointwise matrix multiplier circuitry 210, the example adder circuitry 212, the example concatenation circuitry 302, the example second pointwise matrix multiplier circuitry 304, the example first pointwise convolution circuitry 402, the example convolution block circuitry 404, the example second pointwise convolution circuitry 502, the example depthwise convolution circuitry 504, and the example third pointwise convolution circuitry 506

The programmable circuitry 1012 of the illustrated example includes a local memory 1013 (e.g., a cache, registers, etc.). The programmable circuitry 1012 of the illustrated example is in communication with main memory 1014, 1016, which includes a volatile memory 1014 and a non-volatile memory 1016, by a bus 1018. The volatile memory 1014 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1016 may be implemented by flash memory and/or any other desired type of memory device. Access to the main memory 1014, 1016 of the illustrated example is controlled by a memory controller 1017. In some examples, the memory controller 1017 may be implemented by one or more integrated circuits, logic circuits, microcontrollers from any desired family or manufacturer, or any other type of circuitry to manage the flow of data going to and from the main memory 1014, 1016.

The programmable circuitry platform 1000 of the illustrated example also includes interface circuitry 1020. The interface circuitry 1020 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1022 are connected to the interface circuitry 1020. The input device(s) 1022 permit(s) a user (e.g., a human user, a machine user, etc.) to enter data and/or commands into the programmable circuitry 1012. The input device(s) 1022 can be implemented by, for example, a camera (still or video), a keyboard, a button, a mouse, a touchscreen, a trackpad, a trackball, and/or an isopoint device.

One or more output devices 1024 are also connected to the interface circuitry 1020 of the illustrated example. The output device(s) 1024 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1020 of the illustrated example, thus, typically includes a graphics driver card, a graphics driver chip, and/or graphics processor circuitry such as a GPU.

The interface circuitry 1020 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1026. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1000 of the illustrated example also includes one or more mass storage discs or devices 1028 to store firmware, software, and/or data. Examples of such mass storage discs or devices 1028 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 1032, which may be implemented by the machine readable instructions of FIGS. 7-9, may be stored in the mass storage device 1028, in the volatile memory 1014, in the non-volatile memory 1016, and/or on at least one non-transitory computer readable storage medium such as a CD or DVD which may be removable.

FIG. 11 is a block diagram of an example implementation of the programmable circuitry 1012 of FIG. 10. In this example, the programmable circuitry 1012 of FIG. 10 is implemented by a microprocessor 1100. For example, the microprocessor 1100 may be a general-purpose microprocessor (e.g., general-purpose microprocessor circuitry). The microprocessor 1100 executes some or all of the machine-readable instructions of the flowcharts of FIGS. 7-9 to effectively instantiate the circuitry of FIG. 2 as logic circuits to perform operations corresponding to those machine readable instructions. In some such examples, the circuitry of FIGS. 2 and 3 is instantiated by the hardware circuits of the microprocessor 1100 in combination with the machine-readable instructions. For example, the microprocessor 1100 may be implemented by multi-core hardware circuitry such as a CPU, a DSP, a GPU, an XPU, etc. Although it may include any number of example cores 1102 (e.g., 1 core), the microprocessor 1100 of this example is a multi-core semiconductor device including N cores. The cores 1102 of the microprocessor 1100 may operate independently or may cooperate to execute machine readable instructions. For example, machine code corresponding to a firmware program, an embedded software program, or a software program may be executed by one of the cores 1102 or may be executed by multiple ones of the cores 1102 at the same or different times. In some examples, the machine code corresponding to the firmware program, the embedded software program, or the software program is split into threads and executed in parallel by two or more of the cores 1102. The software program may correspond to a portion or all of the machine readable instructions and/or operations represented by the flowcharts of FIGS. 7-9.

The cores 1102 may communicate by a first example bus 1104. In some examples, the first bus 1104 may be implemented by a communication bus to effectuate communication associated with one(s) of the cores 1102. For example, the first bus 1104 may be implemented by at least one of an Inter-Integrated Circuit (I2C) bus, a Serial Peripheral Interface (SPI) bus, a PCI bus, or a PCIe bus. Additionally or alternatively, the first bus 1104 may be implemented by any other type of computing or electrical bus. The cores 1102 may obtain data, instructions, and/or signals from one or more external devices by example interface circuitry 1106. The cores 1102 may output data, instructions, and/or signals to the one or more external devices by the interface circuitry 1106. Although the cores 1102 of this example include example local memory 1120 (e.g., Level 1 (L1) cache that may be split into an L1 data cache and an L1 instruction cache), the microprocessor 1100 also includes example shared memory 1110 that may be shared by the cores (e.g., Level 2 (L2 cache)) for high-speed access to data and/or instructions. Data and/or instructions may be transferred (e.g., shared) by writing to and/or reading from the shared memory 1110. The local memory 1120 of each of the cores 1102 and the shared memory 1110 may be part of a hierarchy of storage devices including multiple levels of cache memory and the main memory (e.g., the main memory 1014, 1016 of FIG. 10). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1102 may be referred to as a CPU, DSP, GPU, etc., or any other type of hardware circuitry. Each core 1102 includes control unit circuitry 1114, arithmetic and logic (AL) circuitry (sometimes referred to as an ALU) 1116, a plurality of registers 1118, the local memory 1120, and a second example bus 1122. Other structures may be present. For example, each core 1102 may include vector unit circuitry, single instruction multiple data (SIMD) unit circuitry, load/store unit (LSU) circuitry, branch/jump unit circuitry, floating-point unit (FPU) circuitry, etc. The control unit circuitry 1114 includes semiconductor-based circuits structured to control (e.g., coordinate) data movement within the corresponding core 1102. The AL circuitry 1116 includes semiconductor-based circuits structured to perform one or more mathematic and/or logic operations on the data within the corresponding core 1102. The AL circuitry 1116 of some examples performs integer based operations. In other examples, the AL circuitry 1116 also performs floating-point operations. In yet other examples, the AL circuitry 1116 may include first AL circuitry that performs integer-based operations and second AL circuitry that performs floating-point operations. In some examples, the AL circuitry 1116 may be referred to as an Arithmetic Logic Unit (ALU).

The registers 1118 are semiconductor-based structures to store data and/or instructions such as results of one or more of the operations performed by the AL circuitry 1116 of the corresponding core 1102. For example, the registers 1118 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1118 may be arranged in a bank as shown in FIG. 11. Alternatively, the registers 1118 may be organized in any other arrangement, format, or structure, such as by being distributed throughout the core 1102 to shorten access time. The second bus 1122 may be implemented by at least one of an I2C bus, a SPI bus, a PCI bus, or a PCIe bus.

Each core 1102 and/or, more generally, the microprocessor 1100 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1100 is a semiconductor device fabricated to include many transistors interconnected to implement the structures described above in one or more integrated circuits (ICs) contained in one or more packages.

The microprocessor 1100 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1100, in the same chip package as the microprocessor 1100 and/or in one or more separate packages from the microprocessor 1100.

FIG. 12 is a block diagram of another example implementation of the programmable circuitry 1012 of FIG. 10. In this example, the programmable circuitry 1012 is implemented by FPGA circuitry 1200. For example, the FPGA circuitry 1200 may be implemented by an FPGA. The FPGA circuitry 1200 can be used, for example, to perform operations that could otherwise be performed by the example microprocessor 1100 of FIG. 11 executing corresponding machine readable instructions. However, once configured, the FPGA circuitry 1200 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 1100 of FIG. 11 described above (which is a general purpose device that may be programmed to execute some or all of the machine readable instructions represented by the flowchart(s) of FIGS. 7-9 but whose interconnections and logic circuitry are fixed once fabricated), the FPGA circuitry 1200 of the example of FIG. 12 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 7-9. In particular, the FPGA circuitry 1200 may be thought of as an array of logic gates, interconnections, and switches. The switches can be programmed to change how the logic gates are interconnected by the interconnections, effectively forming one or more dedicated logic circuits (unless and until the FPGA circuitry 1200 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 7-9. As such, the FPGA circuitry 1200 may be configured and/or structured to effectively instantiate some or all of the operations/functions corresponding to the machine readable instructions of the flowchart(s) of FIGS. 7-9 as dedicated logic circuits to perform the operations/functions corresponding to those software instructions in a dedicated manner analogous to an ASIC. Therefore, the FPGA circuitry 1200 may perform the operations/functions corresponding to the some or all of the machine readable instructions of FIGS. 7-9 faster than the general-purpose microprocessor can execute the same.

In the example of FIG. 12, the FPGA circuitry 1200 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1200 of FIG. 12 may access and/or load the binary file to cause the FPGA circuitry 1200 of FIG. 12 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1200 of FIG. 12 to cause configuration and/or structuring of the FPGA circuitry 1200 of FIG. 12, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1200 of FIG. 12 may access and/or load the binary file to cause the FPGA circuitry 1200 of FIG. 12 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1200 of FIG. 12 to cause configuration and/or structuring of the FPGA circuitry 1200 of FIG. 12, or portion(s) thereof.

The FPGA circuitry 1200 of FIG. 12, includes example input/output (I/O) circuitry 1202 to obtain and/or output data to/from example configuration circuitry 1204 and/or external hardware 1206. For example, the configuration circuitry 1204 may be implemented by interface circuitry that may obtain a binary file, which may be implemented by a bit stream, data, and/or machine-readable instructions, to configure the FPGA circuitry 1200, or portion(s) thereof. In some such examples, the configuration circuitry 1204 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1206 may be implemented by external hardware circuitry. For example, the external hardware 1206 may be implemented by the microprocessor 1100 of FIG. 11.

The FPGA circuitry 1200 also includes an array of example logic gate circuitry 1208, a plurality of example configurable interconnections 1210, and example storage circuitry 1212. The logic gate circuitry 1208 and the configurable interconnections 1210 are configurable to instantiate one or more operations/functions that may correspond to at least some of the machine readable instructions of FIGS. 7-9 and/or other desired operations. The logic gate circuitry 1208 shown in FIG. 12 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1208 to enable configuration of the electrical structures and/or the logic gates to form circuits to perform desired operations/functions. The logic gate circuitry 1208 may include other electrical structures such as look-up tables (LUTs), registers (e.g., flip-flops or latches), multiplexers, etc.

The configurable interconnections 1210 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1208 to program desired logic circuits.

The storage circuitry 1212 of the illustrated example is structured to store result(s) of the one or more of the operations performed by corresponding logic gates. The storage circuitry 1212 may be implemented by registers or the like. In the illustrated example, the storage circuitry 1212 is distributed amongst the logic gate circuitry 1208 to facilitate access and increase execution speed.

The example FPGA circuitry 1200 of FIG. 12 also includes example dedicated operations circuitry 1214. In this example, the dedicated operations circuitry 1214 includes special purpose circuitry 1216 that may be invoked to implement commonly used functions to avoid the need to program those functions in the field. Examples of such special purpose circuitry 1216 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1200 may also include example general purpose programmable circuitry 1218 such as an example CPU 1220 and/or an example DSP 1222. Other general purpose programmable circuitry 1218 may additionally or alternatively be present such as a GPU, an XPU, etc., that can be programmed to perform other operations.

Although FIGS. 11 and 12 illustrate two example implementations of the programmable circuitry 1012 of FIG. 10, many other approaches are contemplated. For example, FPGA circuitry may include an on-board CPU, such as one or more of the example CPU 1220 of FIG. 11. Therefore, the programmable circuitry 1012 of FIG. 10 may additionally be implemented by combining at least the example microprocessor 1100 of FIG. 11 and the example FPGA circuitry 1200 of FIG. 12. In some such hybrid examples, one or more cores 1102 of FIG. 11 may execute a first portion of the machine readable instructions represented by the flowchart(s) of FIGS. 7-9 to perform first operation(s)/function(s), the FPGA circuitry 1200 of FIG. 12 may be configured and/or structured to perform second operation(s)/function(s) corresponding to a second portion of the machine readable instructions represented by the flowcharts of FIG. 7-9, and/or an ASIC may be configured and/or structured to perform third operation(s)/function(s) corresponding to a third portion of the machine readable instructions represented by the flowcharts of FIGS. 7-9.

It should be understood that some or all of the circuitry of FIGS. 2 and 3 may, thus, be instantiated at the same or different times. For example, same and/or different portion(s) of the microprocessor 1100 of FIG. 11 may be programmed to execute portion(s) of machine-readable instructions at the same and/or different times. In some examples, same and/or different portion(s) of the FPGA circuitry 1200 of FIG. 12 may be configured and/or structured to perform operations/functions corresponding to portion(s) of machine-readable instructions at the same and/or different times.

In some examples, some or all of the circuitry of FIGS. 2 and 3 may be instantiated, for example, in one or more threads executing concurrently and/or in series. For example, the microprocessor 1100 of FIG. 11 may execute machine readable instructions in one or more threads executing concurrently and/or in series. In some examples, the FPGA circuitry 1200 of FIG. 12 may be configured and/or structured to carry out operations/functions concurrently and/or in series. Moreover, in some examples, some or all of the circuitry of FIGS. 2 and 3 may be implemented within one or more virtual machines and/or containers executing on the microprocessor 1100 of FIG. 11.

In some examples, the programmable circuitry 1012 of FIG. 10 may be in one or more packages. For example, the microprocessor 1100 of FIG. 11 and/or the FPGA circuitry 1200 of FIG. 12 may be in one or more packages. In some examples, an XPU may be implemented by the programmable circuitry 1012 of FIG. 10, which may be in one or more packages. For example, the XPU may include a CPU (e.g., the microprocessor 1100 of FIG. 11, the CPU 1220 of FIG. 12, etc.) in one package, a DSP (e.g., the DSP 1222 of FIG. 12) in another package, a GPU in yet another package, and an FPGA (e.g., the FPGA circuitry 1200 of FIG. 12) in still yet another package.

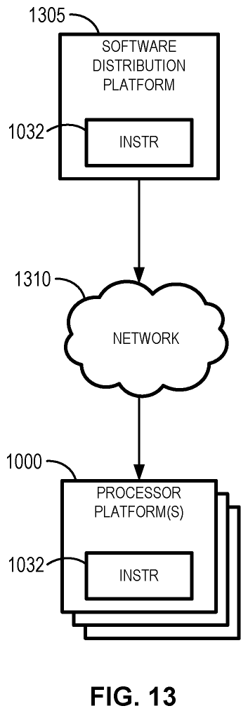

A block diagram illustrating an example software distribution platform 1305 to distribute software such as the example machine readable instructions 1032 of FIG. 10 to other hardware devices (e.g., hardware devices owned and/or operated by third parties from the owner and/or operator of the software distribution platform) is illustrated in FIG. 13. The example software distribution platform 1305 may be implemented by any computer server, data facility, cloud service, etc., capable of storing and transmitting software to other computing devices. The third parties may be customers of the entity owning and/or operating the software distribution platform 1305. For example, the entity that owns and/or operates the software distribution platform 1305 may be a developer, a seller, and/or a licensor of software such as the example machine readable instructions 1032 of FIG. 10. The third parties may be consumers, users, retailers, OEMs, etc., who purchase and/or license the software for use and/or re-sale and/or sub-licensing. In the illustrated example, the software distribution platform 1305 includes one or more servers and one or more storage devices. The storage devices store the machine readable instructions 1032, which may correspond to the example machine readable instructions of FIGS. 7-9, as described above. The one or more servers of the example software distribution platform 1305 are in communication with an example network 1310, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1032 from the software distribution platform 1305. For example, the software, which may correspond to the example machine readable instructions of FIG. 7-9, may be downloaded to the example programmable circuitry platform 1000, which is to execute the machine readable instructions 1032 to implement the SR upscaling circuitry 108. In some examples, one or more servers of the software distribution platform 1305 periodically offer, transmit, and/or force updates to the software (e.g., the example machine readable instructions 1032 of FIG. 10) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that generates super-resolution upscaling for display devices. Disclosed systems, apparatus, articles of manufacture, and methods improve the efficiency of using a computing device by implementing a super-resolution system that is trainable to upscale lower resolution image to generate a super-resolution upscaled image. The super-resolution system includes two branches with the first branch performing a relatively low complexity upscaling of an input image with three-channels and the second branch performing a more complex neural network based upscaling on fewer channel that generates higher quality data. The super-resolution system combines the data from the first and second branches to get a high quality upscale image without upscaling all the channels. Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture to implement super-resolution upscaling are disclosed herein. Further examples and combinations thereof include the following:

Example 1 includes an apparatus to process an image, the apparatus comprising interface circuitry to accept input image data with a first resolution, machine readable instructions, and programmable circuitry to at least one of instantiate or execute the machine readable instructions to upscale the input image data based on an upscale factor to generate intermediate image data with a second resolution higher than the first resolution, process the input image data with a neural network to produce neural network output data with a number of channels per pixel that is based on the upscale factor, and combine the intermediate image data and the neural network output data to generate output image data with the second resolution.

Example 2 includes the apparatus of example 1, wherein the number of channels per pixel is proportional to a square of the upscale factor, and the programmable circuitry is to combine the neural network output data and the intermediate image data by rearranging channels of the neural network output data for a first pixel to form rearranged output data including a spatial block for the first pixel, the spatial block having a number of vertical elements and a number of horizontal elements corresponding to the upscale factor.

Example 3 includes the apparatus of example 2, wherein the intermediate image data is a first intermediate image data, the rearranged output data has one channel per pixel, and the programmable circuitry is to combine the neural network output data and the first intermediate image data by performing pointwise matrix multiplication on the rearranged output data based on trained coefficients to determine second intermediate image data having multiple channels per pixel.

Example 4 includes the apparatus of example 3, wherein the programmable circuitry is to combine the neural network output data and the first intermediate image data by adding the first intermediate image data and the second intermediate image data to determine the output image data.

Example 5 includes the apparatus of example 2, wherein the intermediate image data is a first intermediate image data, the rearranged output data has one channel per pixel, and the programmable circuitry is to combine the neural network output data and the intermediate image data by concatenating the rearranged output data and the first intermediate image data to determine a second intermediate image data having multiple channels per pixel, and performing pointwise matrix multiplication on the second intermediate image data based on trained coefficients to determine the output image data.

Example 6 includes the apparatus of example 1, wherein the neural network includes a first pointwise convolution layer to expand the number of channels based on the upscale factor, and one or more additional convolution layers.

Example 7 includes the apparatus of example 6, wherein the additional convolution layers include a second pointwise convolution layer, a depthwise convolution layer, and a third pointwise convolution layer.

Example 8 includes the apparatus of example 6, wherein the neural network includes a residual connection to add an input of the first pointwise convolution layer to an output of one of the additional convolution layers.

Example 9 includes a non-transitory machine readable storage medium comprising instructions to cause programmable circuitry to at least upscale an input image data with a first resolution based on an upscale factor to generate intermediate image data with a second resolution higher than the first resolution, process the input image data with a neural network to produce neural network output data with a number of channels per pixel that is based on the upscale factor, and combine the neural network output data and the intermediate image data to generate output image data with the second resolution.

Example 10 includes the non-transitory machine readable storage medium of example 9, wherein the number of channels per pixel is proportional to a square of the upscale factor, and the programmable circuitry is to combine the neural network output data and the intermediate image data, by rearranging channels of the neural network output data for a first pixel to form rearranged output data including a spatial block for the first pixel, the spatial block having a number of vertical elements and a number of horizontal elements corresponding to the upscale factor.

Example 11 includes the non-transitory machine readable storage medium of example 10, wherein the intermediate image data is a first intermediate image data, the rearranged output data has one channel per pixel, and the programmable circuitry is to combine the neural network output data and the first intermediate image data by performing pointwise matrix multiplication on the rearranged output data based on trained coefficients to determine second intermediate image data having multiple channels per pixel.

Example 12 includes the non-transitory machine readable storage medium of example 11, wherein the programmable circuitry is to combine the neural network output data and the first intermediate image data by adding the first intermediate image data and the second intermediate image data to determine the output image data.

Example 13 includes the non-transitory machine readable storage medium of example 10, wherein the intermediate image data is a first intermediate image data, the rearranged output data has one channel per pixel, and the programmable circuitry is to combine the neural network output data and the intermediate image data by concatenating the rearranged output data and the first intermediate image data to determine a second intermediate image data having multiple channels per pixel, and performing pointwise matrix multiplication on the second intermediate image data based on trained coefficients to determine the output image data.

Example 14 includes the non-transitory machine readable storage medium of example 9, wherein the neural network includes a first pointwise convolution layer to expand the number of channels based on the upscale factor, and one or more additional convolution layers.

Example 15 includes the non-transitory machine readable storage medium of example 14, wherein the additional convolution layers include a second pointwise convolution layer, a depthwise convolution layer, and a third pointwise convolution layer.

Example 16 includes the non-transitory machine readable storage medium of example 14, wherein the neural network includes a residual connection to add an input of the first pointwise convolution layer to an output of one of the additional convolution layers.

Example 17 includes a method to process an image, the method comprising upscaling an input image data with a first resolution based on an upscale factor to generate intermediate image data with a second resolution higher than the first resolution, processing the input image data with a neural network to produce neural network output data with a number of channels per pixel that is based on the upscale factor, and combining the neural network output data and the intermediate image data to generate output image data with the second resolution.

Example 18 includes the method of example 17, wherein the number of channels per pixel is proportional to a square of the upscale factor, and the combining of the neural network output data and the intermediate image data includes rearranging channels of the neural network output data for a first pixel to form rearranged output data including a spatial block for the first pixel, the spatial block having a number of vertical elements and a number of horizontal elements corresponding to the upscale factor.

Example 19 includes the method of example 18, wherein the intermediate image data is a first intermediate image data, the rearranged output data has one channel per pixel, and the combining of the neural network output data and the first intermediate image data includes performing pointwise matrix multiplication on the rearranged output data based on trained coefficients to determine a second intermediate image data having multiple channels per pixel.

Example 20 includes the method of example 19, wherein the combining of the neural network output data and the first intermediate image data includes adding the first intermediate image data and the second intermediate image data to determine the output image data. Example 21 includes the method of example 18, wherein the intermediate image data is first intermediate image data, the rearranged output data has one channel per pixel, and further including combining the neural network output data and the intermediate image data by concatenating the rearranged output data and the first intermediate data to determine the second intermediate image data having multiple channels per pixel, and performing pointwise matrix multiplication on the second intermediate image data based on trained coefficients to determine the output image data.

Example 22 includes the method of example 17, wherein the neural network includes a first pointwise convolution layer to expand the number of channels based on the upscale factor, and one or more additional convolution layers.

Example 23 includes the method of example 22, wherein the additional convolution layers include a second pointwise convolution layer, a depthwise convolution layer, and a third pointwise convolution layer.

Example 24 includes the method of example 22, wherein the neural network includes a residual connection to add an input of the first pointwise convolution layer to an output of one of the additional convolution layers.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus to process an image, the apparatus comprising:
interface circuitry to accept input image data with a first resolution;
machine readable instructions; and
programmable circuitry to at least one of instantiate or execute the machine readable instructions to:
upscale the input image data based on an upscale factor to generate intermediate image data with a second resolution higher than the first resolution;
process the input image data with a neural network to produce neural network output data with a number of channels per pixel that is based on the upscale factor; and
combine the intermediate image data and the neural network output data to generate output image data with the second resolution.

2. The apparatus of claim 1, wherein the number of channels per pixel is proportional to a square of the upscale factor, and the programmable circuitry is to combine the neural network output data and the intermediate image data by rearranging channels of the neural network output data for a first pixel to form rearranged output data including a spatial block for the first pixel, the spatial block having a number of vertical elements and a number of horizontal elements corresponding to the upscale factor.

3. The apparatus of claim 2, wherein the intermediate image data is a first intermediate image data, the rearranged output data has one channel per pixel, and the programmable circuitry is to combine the neural network output data and the first intermediate image data by performing pointwise matrix multiplication on the rearranged output data based on trained coefficients to determine second intermediate image data having multiple channels per pixel.

4. The apparatus of claim 3, wherein the programmable circuitry is to combine the neural network output data and the first intermediate image data by adding the first intermediate image data and the second intermediate image data to determine the output image data.

5. The apparatus of claim 2, wherein the intermediate image data is a first intermediate image data, the rearranged output data has one channel per pixel, and the programmable circuitry is to combine the neural network output data and the intermediate image data by:
concatenating the rearranged output data and the first intermediate image data to determine a second intermediate image data having multiple channels per pixel; and
performing pointwise matrix multiplication on the second intermediate image data based on trained coefficients to determine the output image data.

6. The apparatus of claim 1, wherein the neural network includes:
a first pointwise convolution layer to expand the number of channels based on the upscale factor; and
one or more additional convolution layers.

7. The apparatus of claim 6, wherein the additional convolution layers include a second pointwise convolution layer, a depthwise convolution layer, and a third pointwise convolution layer.

8. The apparatus of claim 6, wherein the neural network includes a residual connection to add an input of the first pointwise convolution layer to an output of one of the additional convolution layers.

9. A non-transitory machine readable storage medium comprising instructions to cause programmable circuitry to at least:
upscale an input image data with a first resolution based on an upscale factor to generate intermediate image data with a second resolution higher than the first resolution;
process the input image data with a neural network to produce neural network output data with a number of channels per pixel that is based on the upscale factor; and
combine the neural network output data and the intermediate image data to generate output image data with the second resolution.

10. The non-transitory machine readable storage medium of claim 9, wherein the number of channels per pixel is proportional to a square of the upscale factor, and the programmable circuitry is to combine the neural network output data and the intermediate image data, by rearranging channels of the neural network output data for a first pixel to form rearranged output data including a spatial block for the first pixel, the spatial block having a number of vertical elements and a number of horizontal elements corresponding to the upscale factor.

11. The non-transitory machine readable storage medium of claim 10, wherein the intermediate image data is a first intermediate image data, the rearranged output data has one channel per pixel, and the programmable circuitry is to combine the neural network output data and the first intermediate image data by performing pointwise matrix multiplication on the rearranged output data based on trained coefficients to determine second intermediate image data having multiple channels per pixel.

12. The non-transitory machine readable storage medium of claim 11, wherein the programmable circuitry is to combine the neural network output data and the first intermediate image data by adding the first intermediate image data and the second intermediate image data to determine the output image data.

13. The non-transitory machine readable storage medium of claim 10, wherein the intermediate image data is a first intermediate image data, the rearranged output data has one channel per pixel, and the programmable circuitry is to combine the neural network output data and the intermediate image data by:
concatenating the rearranged output data and the first intermediate image data to determine a second intermediate image data having multiple channels per pixel; and
performing pointwise matrix multiplication on the second intermediate image data based on trained coefficients to determine the output image data.

14. The non-transitory machine readable storage medium of claim 9, wherein the neural network includes:
a first pointwise convolution layer to expand the number of channels based on the upscale factor; and
one or more additional convolution layers.

15. The non-transitory machine readable storage medium of claim 14, wherein the additional convolution layers include a second pointwise convolution layer, a depthwise convolution layer, and a third pointwise convolution layer.

16. The non-transitory machine readable storage medium of claim 14, wherein the neural network includes a residual connection to add an input of the first pointwise convolution layer to an output of one of the additional convolution layers.

17. A method to process an image, the method comprising:
upscaling an input image data with a first resolution based on an upscale factor to generate intermediate image data with a second resolution higher than the first resolution;
processing the input image data with a neural network to produce neural network output data with a number of channels per pixel that is based on the upscale factor; and
combining the neural network output data and the intermediate image data to generate output image data with the second resolution.

18. The method of claim 17, wherein the number of channels per pixel is proportional to a square of the upscale factor, and the combining of the neural network output data and the intermediate image data includes rearranging channels of the neural network output data for a first pixel to form rearranged output data including a spatial block for the first pixel, the spatial block having a number of vertical elements and a number of horizontal elements corresponding to the upscale factor.

19. The method of claim 18, wherein the intermediate image data is a first intermediate image data, the rearranged output data has one channel per pixel, and the combining of the neural network output data and the first intermediate image data includes performing pointwise matrix multiplication on the rearranged output data based on trained coefficients to determine second intermediate image data having multiple channels per pixel.

20. The method of claim 19, wherein the combining of the neural network output data and the first intermediate image data includes adding the first intermediate image data and the second intermediate image data to determine the output image data.
